(19) United States
(12) Patent Application Publication
(10) Pub. No.: US 2023/0058970 A1
(43) Pub. Date: Feb. 23, 2023

(54) Geopolymer Composition, A Method For Preparing the Same and Its Uses

(71) Applicant: Una Developments Limited, Plymouth (GB)

(72) Inventor: Aissa Bouaissi, Plymouth (GB)

(21) Appl. No.: 17/784,222

(22) PCT Filed: Dec. 9, 2020
(86) PCT No.: PCT/GB2020/053149

§ 371 Date: Jun. 10, 2022

(30) Foreign Application Priority Data
Dec. 12, 2019 (GB) 1918321.9

(51) Int. Cl. C04B 28/00; C04B 14/02

(52) U.S. Cl. CPC C04B 28/006; C04B 14/022; C04B 2103/0093

(57) ABSTRACT

A geopolymer composition for use as a cement or concrete is provided, the composition comprising: (a) fly ash (FA); (b) ground granulated blast-furnace slag (GGBS); and (c) high-magnesium nickel slag (HMNS). The composition may optionally comprise a filler. A method for forming a geopolymer composition is also provided, the method comprising: providing a geopolymer precursor comprising: (a) fly ash (FA); (b) ground granulated blast-furnace slag (GGBS); and (c) high-magnesium nickel slag (HMNS); combining components (a) to (c) with an activator, the activator comprising a silicate and a base in solution in a solvent; and allowing the resulting mixture to cure. The geopolymer composition advantageously comprises one or more allotropes of carbon, in particular a carbon nano-structure material, for example nanotubes, nanobuds and nanoribbons. The geopolymer composition finds use in form a wide range of construction components and structures.

The present invention relates to a geopolymer composition. The composition finds use, for example, in construction. The geopolymer composition is of particular use when used as a binder and combined with a filler, for example an aggregate to form concrete. The present invention also relates to a method for preparing the geopolymer composition and materials containing the geopolymer composition.

It is well known and established in the art to form a range of construction materials, such as cement and concrete, from Portland cement. While Portland cement has been used extensively for many years, there are considerable environmental issues arising from its preparation and use. The production of Portland cement is highly energy intensive and requires an embodied energy of about 1300 kWh/tonne. In addition, the manufacture of a tonne of Portland cement results in the emission of about 0.8 tonne of carbon dioxide. Portland cement is used extensively in the production of concrete in combination with aggregate. Depending upon the composition of the concrete, the production of one tonne of Portland cement concrete requires about 150 to 250 kWh of embodied energy and products approximately 75 to 175 kg carbon dioxide.

There is a need for an alternative to Portland cement and other similar cements that are more environmentally friendly in both their production and use. A number of alternatives to Portland cement have been proposed in the art.

KR 101332346 discloses an inorganic binder composition comprising aluminosilicate and magnesium silicate minerals. The composition comprises silicon and aluminium in a molar ratio of 0.5 to 4.0, a mixture of SiO₂ and Na₂O in a molar ratio of from 0.5 to 2.5, SiO₂/Li₂O in a molar ratio of 0.5 to 2.5 and SiO₂/K₂O in a molar ratio of 0.5 to 2.5. The binder composition may be prepared by combining appropriate amounts metakaolin, fly ash, blast furnace slag powder or silicafume. The binder composition has lower calcining temperature than conventional cementitious binders.

US 2014/0349104 discloses an inorganic polymer/organic polymer composite and a method of preparing the same. The inorganic polymer is formed by reacting a reactive powder, an activator and, optionally a retardant, in the presence of water. The reactive powder comprises 85% by weight or greater fly ash and less than 10% by weight Portland cement.

US 2015/0251951 concerns the production of bricks from mine tailings using geopolymerisation. A method for producing bricks is disclosed, which method comprises mixing mine tailings, in particular the tailings of copper mining, with alkaline solution. It is indicated that the bricks prepared in this manner do not require high temperature kiln firing.

More recently, WO 2016/023073 discloses geopolymers and geopolymer aggregates. The aggregates may be used in concrete. The geopolymer composition comprises fly ash or a fly ash substitute, an aluminium phyllosilicate, an alkaline component and water. The geopolymer composition is compacted under pressure and cured.

U.S. Pat. No. 8,337,612 discloses an environmentally friendly composite construction material. The material is an alumina-silicate cementitious material and is formed by combining a pozzolanic material and/or a kaolin clay with an activator. The activator comprises sodium silicate and sodium hydroxide. The activator is combined with the pozzolanic material and/or kaolin clay, together with water. The material may be combined with or incorporate an aggregate, to form a concrete.

CN 101239800 discloses an inorganic non-metal fibre-reinforced cement-based composite material.

High-water-permeability concrete water-permeable ground tiles are disclosed in CN 108640617.

It has been found that a geopolymer composition comprising fly ash (FA), ground granulated blast-furnace slag (GGBS) and high-magnesium nickel slag (HMNS) has a number of advantageous properties and is particularly effective as a cementitious material for preparing a range of composite materials, such as concrete, and provides a number of significant advantages in both its preparation and use, compared with the known binder compositions, especially those based on Portland cement.

Accordingly, in a first aspect, the present invention provides a geopolymer composition comprising:

(a) fly ash (FA);

(b) ground granulated blast-furnace slag (GGBS); and

(c) high-magnesium nickel slag (HMNS).

The geopolymer composition of the present invention provides a number of significant advantages. First, the geopolymer can be prepared from components that are by-products of other processes and are generally considered as waste materials, typically disposed of by landfill. In this respect, it is to be noted that the geopolymer composition can be prepared and used without the need for a cement, in particular Portland cement, which generally require large amounts of energy to produce. Further, the geopolymer composition of the present invention can be prepared by a low-energy process, in turn producing minimal emissions.

It is a further significant advantage of the geopolymer composition of the present invention that it does not cure or set until combined with an activator, as described in more detail hereinbelow. As a result, the geopolymer composition is stable during storage and transport and can be combined with the activator only when to be used. Once combined with the activator, the geopolymer composition cures at ambient temperature. Curing or setting of the geopolymer composition requires significantly less water than known cement compositions, for example Portland cement.

The geopolymer composition of the present invention exhibits a significantly faster setting rate, compared with known compositions, in particular Portland cement. Once set, the geopolymer composition exhibits a very high strength, in particular with an increased ability to resist both static and dynamic loads.

Once set, the geopolymer composition of the present invention exhibits a high resistance to chloride migration. The composition also exhibits a high resistance to heat and fire, remaining resistant to heat up to 1000° C. without a substantial loss of strength. Similarly, the composition is also resistant to low temperatures, in particular temperatures well below zero centigrade, again without significant reduction in strength.

The composition is also suitable for use in conditions with exposure to high concentrations of sulphates, being less susceptible to cracking and disintegration due to reactions with sulphate ions.

The geopolymer composition of the present invention also exhibits an increased thermal and electrical conductivity. A further advantage of the composition is that it is compatible with a wide range of filler materials. The thermal and electrical conductivity properties can be enhanced by combining the composition with appropriate fillers, as described in more detail below.

The geopolymer composition of the present invention comprises fly ash (FA), ground granulated blast furnace slag (GGBS) and high-magnesium nickel slag (HMNS). Typical compositions for these components are summarised in Table 1 below. The compositions of these components may vary from those shown in Table 1, for example depending upon the source of the component material, as described in more detail below.

The geopolymer composition of the present invention comprises fly ash (FA). Fly ash is a product of the combustion of coal and, as a result, is produced in large amounts, for example as a result of burning coal to generate electricity. Fly ash is a pozzolan, that is a substance containing aluminous and siliceous material. Depending upon the source and composition of the coal being burned, the components of fly ash vary considerably.

Fly ash has been used in Portland cement concrete as a mineral admixture, and more recently as a component of blended cement. As an admixture, fly ash functions as either a partial replacement for, or an addition to, Portland cement and is added directly into ready-mix concrete at the batch plant. ASTM C595 defines two blended cement products in which fly ash has been added: 1) Portland-pozzolan cement (Type IP), containing 15 to 40 percent pozzolan, or 2) Pozzolan modified Portland cement (Type I-PM), containing less than 15 percent pozzolan.

ASTM C618 defines two classes of fly ash for use in concrete:

1) Class F, typically derived from the burning of anthracite or bituminous coal; and

2) Class C, typically derived from the burning of lignite or subbituminous coal.

ASTM C618 also specifies requirements for the physical, chemical, and mechanical properties for these two classes of fly ash. In particular, Class F fly ash is pozzolanic, with little or no cementing value alone. Class C fly ash has self-cementing properties as well as pozzolanic properties.

In the present invention, any type or class or mixtures thereof may be used. Class F fly ash is preferred for use in the present invention. Preferably, the fly ash employed comprises a major portion of Class F fly ash, that is at least 50% by weight Class F fly ash, more preferably at least 60%, still more preferably at least 70%, more preferably still at least 80%, especially at least 90% by weight, more especially at least 95% by weight Class F fly ash. In a particularly preferred embodiment the fly ash component of the geopolymer composition consists essentially of Class F fly ash.

The geopolymer composition may comprise fly ash in any suitable amount. Preferably, fly ash is present in an amount of at least 40% by weight, more preferably at least 50% by weight, still more preferably at least 55%, more preferably still at least 60% by weight. Preferably, fly ash is present in an amount of up to 90% by weight, more preferably up to 85%, still more preferably up to 80%, more preferably still up to 75% by weight. In preferred embodiments, fly ash is present in an amount of from 40 to 90% by weight, preferably from 50 to 85%, more preferably from 55 to 80%, especially from 60 to 75% by weight.

The geopolymer composition of the present invention further comprises ground granulated blast furnace slag (GGBS). Ground granulated blast furnace slag is obtained by quenching molten iron slag produced in the production of iron and steel. The molten iron slag is removed from the blast furnace and typically quenched in water or steam to produce a glassy, granular product that is then dried and ground into a fine powder.

The composition of the ground granulated blast furnace slag depends upon the raw materials used in the iron or steel production, including the iron ore, coke and the flux employed.

It is known to use ground granulated blast furnace slag in combination with Portland cement to form concrete. Concrete made with ground granulated blast furnace slag cement sets more slowly than concrete made with ordinary Portland cement, depending on the amount of ground granulated blast furnace slag in the cementitious material. This results in a lower heat of hydration and lower temperature rises of the bulk concrete during curing. However, the slower setting rate can be disadvantageous and makes concretes containing significant amounts of ground granulated blast furnace slag undesirable or unacceptable for many applications where a high setting rate is required.

The geopolymer composition of the present invention may comprise ground granulated blast furnace slag in any suitable amount. Preferably, ground granulated blast furnace slag is present in an amount of at least 5% by weight, more preferably at least 10% by weight, still more preferably at least 12%, more preferably still at least 15% by weight. Preferably, ground granulated blast furnace slag is present in an amount of up to 50% by weight, more preferably up to 45%, still more preferably up to 40%, more preferably still up to 35% by weight, especially up to 30% by weight. In preferred embodiments, ground granulated blast furnace slag is present in an amount of from 5 to 50% by weight, preferably from 10 to 40%, more preferably from 12 to 35%, especially from 15 to 30% by weight.

The setting time of the geopolymer composition may be controlled by varying the amount of ground granulated blast furnace slag. In this respect, ground granulated blast furnace slag generally contains a significant amount of calcium oxide (CaO). The amount of calcium oxide present varies, depending upon the source of the ground granulated blast furnace slag and can be determined using X-ray fluorescence (XRF), as known in the art. In the geopolymer composition, Ca++ ions are reactive and accelerate the geopolymerization process. A high concentration of Ca++ ions can lead to the formation of geopolymeric gels at a faster rate, thereby reducing the setting time.

The geopolymer composition of the present invention further comprises high-magnesium nickel slag (HMNS). High-magnesium nickel slag is produced in the smelting of nickel ore and is a hazardous waste material, requiring careful disposal.

The geopolymer composition may comprise high-magnesium nickel slag in any suitable amount. Preferably, high-magnesium nickel slag is present in an amount of at least 1% by weight, more preferably at least 2% by weight, still more preferably at least 3%, more preferably still at least 4%, especially at least 5% by weight. Preferably, high-magnesium nickel slag is present in an amount of up to 40% by weight, more preferably up to 35%, still more preferably up to 30%, more preferably still up to 25% by weight, especially up to 20% by weight. In preferred embodiments, high-magnesium nickel slag is present in an amount of from 1 to 40% by weight, preferably from 2 to 30%, more preferably from 4 to 25%, especially from 5 to 20% by weight.

The fly ash, ground granulated blast furnace slag and high-magnesium nickel slag may be present in the geopolymer composition in any suitable relative amounts.

Fly ash is preferably present in an excess amount by weight than the ground granulated blast furnace slag, that is the weight ratio of fly ash and ground granulated blast furnace slag is greater than 1:1, preferably greater than 1.3:1, more preferably greater than 1.5:1, still more preferably greater than 1.75:1, especially greater than 2:1. The fly ash and ground granulated blast furnace slag may be present in a weight ratio of up to 12:1, preferably up to 10:1, more preferably up to 8:1, still more preferably up to 6:1, especially up to 5:1. In particular, the fly ash and ground granulated blast furnace slag may be present in a weight ratio of fly ash to ground granulated blast furnace slag of from 1.1:1 to 10:1, preferably from 1.3:1 to 8:1, more preferably from 1.5:1 to 7:1, still more preferably from 1.75:1 to 6:1, especially from 2:1 to 5:1. A weight ratio of fly ash and ground granulated blast furnace slag of about 3.5 is preferred for many embodiments.

Fly ash is preferably present in an excess amount by weight than the high-magnesium nickel slag, that is the weight ratio of fly ash and high-magnesium nickel slag is greater than 1:1, preferably greater than 1.5:1, more preferably greater than 2:1, still more preferably greater than 2.5:1, especially greater than 3:1. The fly ash and high-magnesium nickel slag may be present in a weight ratio of up to 30:1, preferably up to 25:1, more preferably up to 20:1, still more preferably up to 17.5:1, especially up to 15:1. In particular, the fly ash and high-magnesium nickel slag may be present in a weight ratio of fly ash to high-magnesium nickel slag of from 1.5:1 to 30:1, preferably from 2:1 to 25:1, more preferably from 2.5:1 to 20:1, still more preferably from 2.75:1 to 17.5:1, especially from 3:1 to 15:1. A weight ratio of fly ash and high-magnesium nickel slag of about 7:1 is preferred for many embodiments.

Ground granulated blast furnace slag and high-magnesium nickel slag may be present in the composition in a weight ratio of from 10:1 to 1:2, preferably from 8:1 to 1:1.7, more preferably from 7:1 to 1:1.5, especially from 6:1 to 1:1.33. Ground granulated blast furnace slag is preferably present in an excess amount by weight than the high-magnesium nickel slag, that is the weight ratio of ground granulated blast furnace slag and high-magnesium nickel slag is greater than 1:1, preferably greater than 1.3:1, more preferably greater than 1.5:1, still more preferably greater than 1.75:1, especially greater than or about 2:1. The ground granulated blast furnace slag and high-magnesium nickel slag may be present in a weight ratio of up to 10:1, preferably up to 8:1, more preferably up to 7:1, still more preferably up to 6:1, especially up to 5:1. In particular, the ground granulated blast furnace slag and high-magnesium nickel slag may be present in a weight ratio of ground granulated blast furnace slag to high-magnesium nickel slag of from 1.3:1 to 10:1, preferably from 1.5:1 to 8:1, more preferably from 1.75:1 to 7:1, still more preferably from 2:1 to 6:1. A weight ratio of ground granulated blast furnace slag and high-magnesium nickel slag of about 2:1 is particularly preferred for many embodiments.

In use, the components of the geopolymer composition are preferably combined to form a dry mixture. This dry mixture is then used in further processing, as described further below.

The geopolymer composition of the present invention finds particular use as a cementitious material, which finds particular use when combined with one or more fillers, as described in more detail below.

To be used as a cement, the geopolymer composition is required to be activated. The geopolymer composition is activated by an activator. The activator is alkaline and comprises a silicate and a base in solution in a suitable solvent.

In a further aspect, the present invention provides a method for forming a geopolymer composition, the method comprising:

providing a geopolymer precursor:

(a) fly ash (FA);

(b) ground granulated blast-furnace slag (GGBS); and

(c) high-magnesium nickel slag (HMNS);

combining components (a) to (c) with an activator, the activator comprising a silicate and a base in solution in a solvent; and

allowing the resulting mixture to cure.

The silicate employed in the activator may be any suitable silicate. Suitable silicates include silicates of alkali metals and alkaline earth metals. Alkali metal silicates are preferred, in particular, potassium silicate and sodium silicate. Sodium silicate is a preferred silicate.

The base employed in the activator may be any suitable base. The base is preferably an inorganic base, in particular a basic metal salt or an ammonium salt. It is preferred to employ a basic metal salt, in particular a salt of an alkali metal, for example potassium or sodium, or an alkaline earth metal, for example calcium. Alkali metal salts are preferred, in particular potassium and sodium. Any suitable basic salt may be employed, such as hydroxides and carbonates, with hydroxides being preferred. Sodium hydroxide is a preferred base. A single base may be employed, for example sodium hydroxide (NaOH). Alternatively, two or more bases, such as a combination of sodium hydroxide (NaOH) and/or calcium hydroxide (Ca(OH)₂) and sodium carbonate (Na₂CO₃), may be employed.

The solvent may be any solvent suitable for dissolving both the silicate and the base. Water is a particularly preferred solvent.

The silicate is preferably provided in a solution in the solvent. The silicate solution may have any suitable concentration. Preferably, the concentration of silicate ions in the silicate solution is from 10% by weight, more preferably from 15%, still more preferably from 20%, more preferably still from 25% by weight. The silicate ions may be present in a concentration of up to 50% by weight, preferably up to 45%, more preferably up to 40%, still more preferably up to 35%, especially up to 30% by weight. A silicate ion concentration of from 20 to 35% by weight, especially from 25 to 30% by weight is especially preferred for many embodiments.

The silicate may be in the form of a mixture of silica (SiO₂) and an oxide. In this case, the weight ratio of silica and oxide is preferably from 2 to 4, more preferably from 2.5 to 3.5, especially from 2.4 and 3.4.

The base is preferably provided in a solution in the solvent. The solution may have any suitable concentration. Preferably, the concentration of basic anions in the solution is from 5M, more preferably from 7M, still more preferably from 9M more preferably still from 11M. The basic anions may be present in a concentration of up to 15M, preferably up to 14M, more preferably up to 13M. A basic anion concentration of from 10M to 14M, especially from 11M to 13M, in particular about 12M is especially preferred for many embodiments.

The silicate and the base of the activator may be employed separately, that is as separate solutions in the solvent. More preferably, the two are combined to form a single activator solution, which is then combined with the dry geopolymer components described above.

The silicate and the base may be employed in the activator in any suitable amounts. The silicate and base are preferably employed in amounts to provide a weight ratio of silicate ions to basic anions of greater than 1:1, that is the silicate ions are present in a weight excess. Preferably the weight ratio of silicate and basic ions is from 1.5:1, more preferably from 2:1, still more preferably from 2.5:1, more preferably still from 3:1, especially from 3.5:1. The weight ratio of silicate and basic ions may be up to 8:1, preferably up to 6:1, more preferably up to 5:1, still more preferably up to 4.5:1. The weight ratio of silicate and basic ions is preferably from 1.5:1 to 8:1, more preferably from 2:1 to 6:1, sill more preferably from 2.5:1 to 5:1, more preferably still from 3:1 to 4.5:1. A weight ratio of about 4:1 is preferred for many embodiments.

The geopolymer composition and the activator may be employed in any suitable amount to provide the proper curing and setting of the geopolymer. The relative amounts of the geopolymer composition and the activator will depend, for example on the composition of the geopolymer and the concentration of the components of the activator. In many embodiments, the weight ratio of the geopolymer components to the activator solution is greater than 1, preferably from 1.1:1, more preferably from 1.3:1, still more preferably from 1.5:1, still more preferably from 1.75:1. The weight ratio of the geopolymer components to the activator solution may be up to 5:1, preferably up to 4:1, more preferably up to 3:1, still more preferably up to 2.5:1. A weight ratio of geopolymer components and activator solution of from 1.1:1 to 5:1 may be used, preferably from 1.3:1 to 4:1, more preferably from 1.5:1 to 3:1, still more preferably from 1.75:1 to 2.5:1. A weight ratio of the dry geopolymer components (FA, GGBS and HMNS) and the activator solution of about 2 is particularly preferred for many embodiments.

The composition of the activator may be varied according to the composition of the geopolymer components. For example, if the amount of alumina, silica and calcium oxide in the geopolymer components is high, for example greater than 70% by weight, the basic anions should be employed in higher amounts, to ensure proper dissolution of the aforementioned oxides; for example when employing —OH anions, the concentration of anions in the base solution should be greater than 10M.

Further, the concentration of the cations of the activator, such as sodium cations (Na+) are active in the formation of sodium aluminosilicate hydrate (N-A-S—H) gels, due to the chemical and physical interaction of Na+ ions with the Al³⁺ion vacancies within the geopolymeric matrix.

In addition, the higher the amount of crystalline material present in the geopolymer composition, as compared with amorphous or semi-amorphous forms, the greater the amount of basic anions required. The crystallinity of the components of the geopolymer may be determined using X-ray diffraction (XRD) techniques, known in the art.

The components of the geopolymer composition, that is fly ash, ground granulated blast furnace slag and high-magnesium nickel slag, may be provided separately. More preferably, the components are combined, for example by mixing.

The geopolymer components are preferably stored and transported as dry components. However, the components may be combined with water to form a slurry. This may allow the component to be pumped as a slurry, which may be advantageous for delivering the components to the site of end use.

As noted above, when it is required to cure the geopolymer components to form the geopolymer composition, the geopolymer components are combined with the activator, as a single solution or as a separate silicate solution and base solution. The geopolymer components may be combined with the activator in any suitable manner. For example, the geopolymer components and the activator may be combined in a suitable vessel with simple mixing. The resulting mixture is then allowed to cure and set. This can be carried out at ambient temperature without any heat being provided to the mixture.

After the geopolymer components and the activator have been combined, the resulting mixture may be employed, for example as a cement or to form articles or components, such as by casting or moulding.

The geopolymer composition of the present invention is advantageous in that it is compatible with a wide range of filler materials. The filler materials can be selected to provide the cured geopolymer composition with a wide range of desirable and advantageous properties, as will now be described in more detail.

In one embodiment, the geopolymer composition comprises an aggregate, allowing the composition to be employed as a concrete. Suitable aggregate materials are well known in the art and include all the commercially available aggregate materials in their commercially available grades. Suitable aggregates include sand, fine gravel and course gravel. The range of suitable aggregates will be well known to the person skilled in the art.

When the geopolymer composition is to include an aggregate, the aggregate is preferably combined with the geopolymer components before or at the same time as the addition of the activator. It is preferred to saturate the aggregate with the solvent employed in the activator, more preferably water, prior to combining the aggregate with the geopolymer components and the activator. In this way, the absorption of the activator solution by the aggregate is reduced.

In another embodiment, the geopolymer composition may comprise carbon in one or more forms. The inclusion of carbon in the geopolymer composition can provide the composition with advantageous properties, for example increased thermal conductivity and increased electrical conductivity. A range of different forms or allotropes of carbon may be employed, for example graphite, graphene, fullerene and nano-carbon structures. In one preferred embodiment, the geopolymer composition comprises carbon in the form of one or more nano-structures, for example nanotubes, nanobuds and nanoribbons.

The one or more forms of carbon are preferably combined with the geopolymer components before the use of the activator. It has been found that combining forms of carbon with the geopolymer components is significantly improved if the carbon materials are first suspended in a suitable solvent. The suspension may then be combined with the geopolymer components (fly ash, ground granulated blast furnace slag and high-magnesium nickel slag). Thereafter, the resulting mixture may be dried to remove and recover the solvent. The resulting mixture may then be combined with the activator. Combining the carbon materials with the geopolymer components in this way improves the distribution of the carbon materials throughout the geopolymer composition and results in improved homogeneity of the final material.

Any suitable solvent may be employed to suspend the carbon materials. For example, water may be used. Preferably, an organic solvent is employed, as this facilitates forming a homogeneous dispersion of the carbon material in the solvent. Suitable organic solvents are those that allow a suspension of the carbon material to be formed. Preferred organic solvents are those having a boiling point below the boiling point of water, preferably solvents having a boiling point below 95° C., more preferably below 90° C., still more preferably below 85° C., more preferably still below 80° C., especially below 75° C., more especially below 70° C., in particular below 65° C. Suitable organic solvents include alcohols, aldehydes and ketones, with ketones being particularly preferred, especially the C₃ to C₈ ketones, more especially the C₃ to C₆ ketones, in particular acetone.

The technique of combining allotropes of carbon with geopolymer components using a solvent is applicable more generally to a range of geopolymer compositions.

Accordingly, in a further aspect, the present invention provides a method for forming a geopolymer composition comprising one or more of fly ash, granulated blast furnace slag and high-magnesium nickel slag and one or more allotropes of carbon, the method comprising:

i) providing a suspension of the carbon allotrope in a solvent;

ii) combining the suspension provided in step i) with one or more of fly ash, granulated blast furnace slag and high-magnesium nickel slag; and

iii) combining the resulting mixture with an activator.

Details and preferred embodiments of the solvent, the geopolymer components and the activator are as hereinbefore described.

The one or more carbon materials may be present in the geopolymer composition in any suitable amount to provide the required properties, for example the required thermal or electrical conductivity. The carbon material is preferably present in an amount of from 0.2% by weight, more preferably from 0.4%, still more preferably from 0.6%, more preferably still from 0.8%, especially from 1%, more especially from 1.2% by weight. The carbon material may be present in an amount up to 10% by weight, preferably up to 8%, more preferably up to 7%, still more preferably up to 6%, especially up to 5% by weight. The carbon materials may be present in the geopolymer composition in an amount of from 0.2 to 10% by weight, preferably from 0.4 to 8%, more preferably from 0.6 to 7%, still more preferably from 0.8 to 6%, more preferably still from 1 to 5% by weight. An amount of from 1.5 to 4% by weight is preferred for many embodiments.

Including carbon material in the geopolymer composition improves a number of properties of the geopolymer composition. First, the inclusion of carbon materials, such as carbon nanotubes, can increase the strength of the geopolymer composition. Further, inclusion of the carbon material increases the thermal conductivity and electrical conductivity of the cured material, as noted above. This provides a number of significant advantages.

First, the cured geopolymer composition can be used in situations where heating is required. Heat can be generated by passing an electrical current through the geopolymer composition. Such situations where heating is required include roads, runways, walkways and footpaths, bridges and the like. Construction components formed from the geopolymer composition, such as bricks, blocks, slabs, or tiles, such as tiles for walls and flooring, may be used to provide heating in domestic, commercial and industrial applications.

In a further aspect, the present invention provides a method for heating, the method comprising providing a geopolymer composition, the geopolymer composition comprising:

(a) fly ash (FA);

(b) ground granulated blast-furnace slag (GGBS);

(c) high-magnesium nickel slag (HMNS); and

(d) a carbon material;

the method comprising passing an electric current through the composition.

Further, the ability of the geopolymer composition to conduct and electrical current can be used in a non-destructive method for detecting flaws in poured, cast or moulded components, such as components for buildings and other structures, such as bridges and tunnels. Flaws in the finished component, such as cracks and voids, will become apparent when the electrical conductivity of the bulk material is measured and will be revealed as regions of low or zero conductivity. This method also allows the condition of components made using the geopolymer composition to be monitored over time, for example to detect degradation of the composition.

In a further aspect, the present invention provides a method for detecting flaws in a geopolymer composition, the geopolymer composition comprising:

(a) fly ash (FA);

(b) ground granulated blast-furnace slag (GGBS);

(c) high-magnesium nickel slag (HMNS); and

(d) a carbon material;

the method comprising measuring the electrical conductivity of the composition.

The carbon materials may be distributed throughout the bulk of the geopolymer composition. In an alternative embodiment, components may be formed having a bulk comprising the geopolymer composition described above, that is fly ash, ground granulated blast furnace slag and high-magnesium nickel slag, and a surface layer formed from the geopolymer composition further comprising the carbon materials. In this way, the use of carbon materials is confined to the surface layer. The surface layer may be formed together with the bulk of the component, for example by casting or moulding the bulk composition and the surface layer composition together in the same mould. Alternatively, the surface layer may be applied to component, for example using a suitable adhesive.

Other filler materials that may be included in the geopolymer composition include rubber, for example natural rubber, synthetic rubber, recycled rubber, such as rubber crumb recovered from used vehicle tyres. Elastomers, such as recycled elastomer materials, may also be used as fillers. Other filler materials include plant materials, such as sugar powder waste, natural fibres derived from plants, such as cotton, flax, jute, ramie and hemp. Inorganic fillers may also be used, for example silica, and oxides of aluminium, calcium, titanium, iron and magnesium. Suitable fillers are known in the art and advantageously include materials that are generally considered as waste materials.

In a further aspect, the present invention provides a component or structure formed from a geopolymer composition as hereinbefore described.

Embodiments of the present invention will now be described, for illustration purposes only, by way of the following examples.

Percentages are weight percent, unless otherwise indicated.

### EXAMPLES

### Example 1— Geopolymer Composition

A geopolymer composition was prepared from fly ash (FA), ground granulated blast furnace slag (GGBS) and high-magnesium nickel slag (HMNS), together with an alkaline activator, as follows:

Class F FA was obtained from Manjung power plant at Perak in Malaysia. The average particle size of the FA was about 18 μm. The specific surface area of the FA was around 1.29 m²/g.

GGBS was obtained from the steel plant at Penang in Malaysia. The average particle size of the GGBS was about 138 μm. The specific surface area of the GGBS was around 0.106 m²/g.

HMNS was obtained from the steel plant in Shaanxi Province, China. The average particle size of the HMNS was about 280 μm. The specific surface area of the HMNS was around 0.0536 m²/g.

The chemical compositions of the FA, GGBS and HMNS are summarised in Table 1, which were determined using x-ray fluorescence analysis.

TABLE 1

| | Class FA | GGBS | HMNS |
|---|---|---|---|
| Component | (wt %) | (wt %) | (wt %) |
| SiO₂ | 55.7 | 28.2 | 43.22 |
| Al₂O₃ | 27.8 | 9.73 | 4.35 |
| Fe₂O₃ | 7.27 | 0.98 | 10.34 |
| CaO | 4.10 | 52.69 | 3.45 |
| TiO₂ | 2.29 | 1.01 | 0.1 |
| SO₃ | 0.27 | 1.46 | 0.28 |
| K₂O | 1.55 | 1.22 | 0.18 |
| MgO | — | 2.9 | 26.15 |
| MnO | — | 0.74 | 0.89 |
| P₂O₅ | — | — | 0.05 |
| Na₂O | — | — | 0.23 |
| Cr₂O₃ | — | — | 1.01 |
| LOI | 3.04 | 3.76 | 0.3 |
| Others | 1.018 | 1.05 | 9.4 |

An alkaline activator was prepared as follows:

A sodium silicate solution was obtained from South Pacific Chemicals Industries (SPCI) Ltd in Malaysia, with the chemical composition of 14.7 wt % Na₂O, 29.8 wt % SiO₂, and 55.5 wt % water.

A sodium hydroxide solution was prepared in the laboratory by dissolving sodium hydroxide pellets in water. To prepare the sodium hydroxide solution with a concentration of 12M, 480 grams of sodium hydroxide pellets supplied by Formosa Plastic Corporation, Taiwan were dissolved in 1 litre of distilled water. After cooling for 24 hours at room temperature, the sodium hydroxide solution was then mixed with the sodium silicate solution.

The mass ratio of sodium silicate to sodium hydroxide solution was 2.5. This provides a weight ratio of silicate ions and hydroxide ions of about 4:1.

The FA, GGBS, HMNS and activator solution were combined in the amounts indicated in Table 2 below.

TABLE 2

| Component | Example 1 |
|---|---|
| Class F FA (kg/m³) | 420 |
| GGBS (kg/m³) | 120 |
| HMNS (kg/m³) | 60 |
| Na₂SiO₃ solution (kg/m³) | 214.28 |
| NaOH solution (12M) (kg/m³) | 85.71 |
| Na₂SiO₃/NaOH weight ratio | 2.5 |
| Solid/alkaline activator weight ratio | 2.0 |

To prepare the geopolymer composition, the solid FA, GGBS and HMNS were placed in a mixing vessel and stirred to form a dry mixture. The activator solution was added to the dry mixture and the mixture stirred to form a uniform paste.

The geopolymer paste was placed in cubic moulds and covered with a plastic film for 24 hours. Thereafter, the contents of the moulds were removed and cured at room temperature (25+/−2° C.) at a relative humidity of 85 to 90%.

Samples of the geopolymer composition were allowed to cure for 7 or 14 days before testing.

### Examples 2 to 4— Geopolymer Compositions

The method of Example 1 above was repeated to prepare geopolymer compositions having a range of compositions.

The compositions of the geopolymer compositions are summarised in Table 3 below.

TABLE 3

| Component | Example 2 | Example 3 | Example 4 |
|---|---|---|---|
| Class F FA | 450 | 390 | 300 |
| (kg/m³) | | | |
| GGBS (kg/m³) | 120 | 120 | 120 |
| HMNS (kg/m³) | 30 | 90 | 120 |
| Na₂SiO₃ solution | 214.28 | 214.28 | 214.28 |
| (kg/m³) | | | |
| NaOH solution | 85.71 | 85.71 | 85.71 |
| (12M) (kg/m³) | | | |
| Na₂SiO₃/NaOH | 2.5 | 2.5 | 2.5 |
| weight ratio | | | |
| Solid/alkaline | 2.0 | 2.0 | 2.0 |
| activator weight ratio | | | |

### Example 5— Setting Time Tests

The setting time of the geopolymer composition of Example 1 was determined using a Vicat apparatus.

The initial setting time was taken to be the time elapsed from the addition of the activator solution to the dry mixture to the point in time when the paste began to lose its elasticity.

The final setting time was taken to be the time elapsed from the addition of the activator solution to the dry mixture to the point in time when the paste lost all its elasticity.

The results are set out in Table 4 below.

TABLE 4

| | Initial Setting Time | Final Setting Time |
|---|---|---|
| | (min) | (min) |
| Example 1 | 310 | 1490 |

### Example 6— Strength Tests of Geopolymer Composition

The cured samples of Examples 1 to 4 were subjected to a test to determine their compressive strength.

The compressive strength tests were performed using a universal testing machine, under a load control regime with a loading rate of 0.3 kN/s in accordance with the ASTM C496 standard.

All tests were carried out in triplicate and average values were obtained and used as the results.

The results of the compressive strength tests are summarised in Table 5 below.

TABLE 5

| Example No. and Curing Time | Compressive Strength (MPa) |
|---|---|
| Example 1 - 7 days | 39.95 |
| Example 1 - 14 days | 60.82 |
| Example 2 - 7 days | 35.69 |
| Example 2 - 14 days | 47.54 |
| Example 3 - 7 days | 32.79 |
| Example 3 - 14 days | 38.56 |
| Example 4 - 7 days | 33.15 |
| Example 4 - 14 days | 47.78 |

### Example 7— Concrete Composition

A concrete composition was prepared from a geopolymer composition comprising fly ash (FA), ground granulated blast furnace slag (GGBS) and high-magnesium nickel slag (HMNS), together with an alkaline activator, and aggregate as follows:

Class F FA was obtained from Manjung power plant at Perak in Malaysia. The average particle size of the FA was about 18 μm. The specific surface area of the FA was around 1.29 m²/g.

GGBS was obtained from the steel plant at Penang in Malaysia. The average particle size of the GGBS was about 138 μm. The specific surface area of the GGBS was around 0.106 m²/g.

HMNS was obtained from the steel plant in Shaanxi Province, China. The average particle size of the HMNS was about 280 μm. The specific surface area of the HMNS was around 0.0536 m²/g.

The chemical compositions of the FA, GGBS and HMNS are summarised in Table 1 above.

An alkaline activator was prepared as follows:

A sodium silicate solution was obtained from South Pacific Chemicals Industries (SPCI) Ltd in Malaysia, with the chemical composition of 14.7 wt % Na₂O, 29.8 wt % SiO₂, and 55.5 wt % water.

A sodium hydroxide solution was prepared in the laboratory by dissolving sodium hydroxide pellets in water. To prepare the sodium hydroxide solution with a concentration of 12M, 480 grams of sodium hydroxide pellets supplied by Formosa Plastic Corporation, Taiwan were dissolved in 1 litre of distilled water. After cooling for hours at room temperature, the sodium hydroxide solution was then mixed with the sodium silicate solution.

The mass ratio of sodium silicate to sodium hydroxide solution was 2.5.

River sand of particle sizes not exceeding 5 mm and gravel of particle sizes ranging from 5 mm and 19 mm were used as the fine and coarse aggregates, respectively. The density of the fine aggregate was 1640 kg/m³. The density of the coarse aggregate was 1204 kg/m³.

The mass ratio of fine aggregate to coarse aggregate was 3:7 for all experiments.

The coarse aggregate was saturated in water for about 2 hours, then left to dry at a room temperature of 25+/−2° C. and a relative humidity of 85 to 90% for another 1 hour until the water film on the surface visibly vanished, before it was mixed with the dry binder composition and alkaline activator solution. This was to ensure that the gravel would not absorb excessive amounts of the activator solution when the components were mixed together.

The FA, GGBS, HMNS, aggregate and activator solution were combined in the amounts indicated in Table 6 below.

TABLE 6

| Component | Example 7 |
|---|---|
| Class F FA (kg/m³) | 336 |
| GGBS (kg/m³) | 96 |
| HMNS (kg/m³) | 48 |
| Na₂SiO₃ solution (kg/m³) | 171.43 |
| NaOH solution (12M) (kg/m³) | 68.6 |
| Coarse aggregate (kg/m³) | 1176 |
| Fine aggregate (kg/m³) | 504 |
| Na₂SiO₃/NaOH weight ratio | 2.5 |
| Solid binder/alkaline activator weight ratio | 2.0 |

To prepare the concrete composition, the solid FA, GGBS, HMNS and aggregates were placed in a mixing vessel and stirred to form a dry mixture. The activator solution was added to the dry mixture and the mixture stirred until uniform.

The concrete composition was placed in cubic moulds and covered with a plastic film for 24 hours. Thereafter, the contents of the moulds were removed and cured at room temperature (25+/−2° C.) at a relative humidity of 85 to 90%.

Samples of the concrete composition were allowed to cure for 7, 14, 28 and 90 days before testing.

### Example 8— Concrete Compositions

The method of Example 7 above was repeated to prepare a concrete composition.

The composition of the concrete composition is summarised in Table 7 below.

TABLE 7

| Component | Example 8 |
|---|---|
| Class F FA (kg/m³) | 222.6 |
| GGBS (kg/m³) | 63.6 |
| HMNS (kg/m³) | 31.8 |
| Na₂SiO₃ solution (kg/m³) | 113.6 |
| NaOH solution (12M) (kg/m³) | 45.5 |
| Coarse aggregate (kg/m³) | 779 |
| Fine aggregate (kg/m³) | 333.7 |
| Na₂SiO₃/NaOH weight ratio | 2.5 |
| Solid binder/alkaline activator weight ratio | 2.0 |

The concrete composition was placed in cylindrical moulds and covered with a plastic film for 24 hours. Thereafter, the contents of the moulds were removed and cured at room temperature (25+/−2° C.) at a relative humidity of 85 to 90%.

Samples of the concrete composition were allowed to cure for 7, 14, 28 and 90 days before testing.

### Example 9— Slump Test

The slump of the concrete composition of Example 7 was tested from the point in time the mixture was removed from the mould to the point in time when the slump reached zero.

The results are set out in Table 8 below.

TABLE 8

| Time (min) | Slump (mm) |
|---|---|
| 0 | 220 |
| 40 | 115 |
| 80 | 70 |
| 120 | 55 |
| 160 | 40 |
| 200 | 25 |
| 240 | 15 |
| 280 | 0 |

### Example 10— Strength Tests of Concrete Composition

The cured concrete samples of Example 7 were subjected to a test to determine their compressive strength.

The compressive strength tests were performed using a universal testing machine, under a load control regime with a loading rate of 0.3 kN/s in accordance with the ASTM C496 standard.

All tests were carried out in triplicate and average values were obtained and used as the results.

The results of the compressive strength tests are summarised in Table 9 below.

TABLE 9

| Curing Time (days) | Compressive Strength (MPa) |
|---|---|
| 7 | 27.17 |
| 14 | 43.43 |
| 28 | 55.6 |
| 90 | 48.14 |

The cured concrete samples of Example 7 were subjected to a test to determine their splitting tensile strength.

The splitting tensile strength tests were performed using a universal testing machine, under a load control regime with a constant load rate of 1.0 kN/min in accordance with the ASTM C496 standard.

All tests were carried out in triplicate and average values were obtained and used as the results.

The results of the compressive strength tests are summarised in Table 10 below.

TABLE 10

| Curing Time (days) | Splitting Tensile Strength (MPa) |
|---|---|
| 7 | 2.89 |
| 14 | 3.65 |
| 28 | 4.57 |
| 90 | 4.12 |

### Example 11— Chloride Ion Migration Tests of Concrete Composition

Cured concrete samples prepared by the method of Example 7 were subjected to a test to determine the extent of chloride ion migration.

To investigate the migration of chloride ions into the concrete composition, a Rapid Chloride Permeability Test (RCPT) was conducted according to the procedure described in Nord Test Standard (NT Build 492, 1999).

In summary, in the test, a sample of the concrete composition was held in a rubber sleeve between an anode and a cathode while immersed in a reservoir containing, as a catholyte, a solution of NaCl and tap water (100 g of NaCl for each 900 g of tap water). The rubber sleeve contained an anolyte solution comprising 0.3M NaOH in de-ionised water. The temperature was maintained to be from 20 to 25° C. A DC voltage was applied across the anode and cathode.

After testing, each sample was split axially and a silver nitrate solution (0.1N AgNO₃) was sprayed onto the faces of the split. The depth of the region of change of colour was measured using a ruler and caliper at intervals along the sample and the average depth calculated.

The chloride migration coefficient is obtained using Fick's Second Law:

$${D}_{n s s m} = \frac{0.0 \; 239 ( 273 + T ) * L}{( U - 2 ) * t} ( {X}_{d} - 0.0238 \sqrt{\frac{( 273 + T ) * L * {X}_{d}}{U - 2}} )$$

where:

Dₙₛₛₘ is the non-steady-state migration coefficient [x10⁻¹² m²/s];

U is the absolute value of the applied voltage [V];

T is the average value of the temperature of the anolyte solution [° C.];

L is the thickness of the specimen [mm];

X_{d} is the average value of the penetration depths [mm]; and

t is the duration of the test [Hours].

The results after 75 and 210 days are summarised in Tables 11a and 11b below.

TABLE 11a

| | | | | Chloride |
|---|---|---|---|---|
| | | | | Migration |
| | | | | Coefficient |
| | | | | Dₙₛₛₘ at |
| | Average | Temperature | Applied | 75 days |
| Sample | Depth | (+/−2) | Voltage | (×10⁻¹¹ |
| No. | (mm) | (° C.) | (V) | m²/s) |
| 1 | 11.60 | 18.2 | 15 | 0.66 |
| 2 | 7.10 | 18.2 | 15 | 0.55 |
| 3 | 9.40 | 18.2 | 15 | 0.77 |
| Average | 9.37 | | | 0.66 |

TABLE 11b

| | | | | Chloride |
|---|---|---|---|---|
| | | | | Migration |
| | | | | Coefficient |
| | | | | Dₙₛₛₘ at |
| | Average | Temperature | Applied | 210 days |
| Sample | Depth | (+/−2) | Voltage | (×10⁻¹¹ |
| No. | (mm) | (° C.) | (V) | m²/s) |
| 1 | NA | 20 | 20 | NA |
| 2 | 11.96 | 20 | 15 | 1.032 |
| 3 | 8.47 | 20 | 15 | 0.689 |
| Average | 10.21 | | | 0.86 |

### Example 12— Thermal Resistance Tests of Concrete Composition

Cured concrete samples prepared by the method of Example 7 were subjected to a test to determine their thermal resistance.

Each sample was heated in an oven with the temperature increased at a rate of 6° C./min until the test temperature was reached. The sample was held at the test temperature for 2 hours. The sample was then allowed to cool to room temperature.

The compressive strength of each sample was measured both before and after heating. The compressive strength tests were performed using a universal testing machine, under a load control regime with a loading rate of 0.3 kN/s in accordance with the ASTM C496 standard.

All tests were carried out in triplicate and average values were obtained and used as the results.

The results are set out in Table 12 below.

TABLE 12

| | Compressive | | Reduction in |
|---|---|---|---|
| Test | strength after | | compressive |
| Temperature | heating | Standard | strength |
| (° C.) | (MPa) | Error | (%) |
| Ambient (20° C.) | 48.40 | 2.4205 | — |
| 200 | 49.84 | 2.492 | −2.96 |
| 300 | 31.19 | 1.56 | 35.54 |
| 400 | 31.05 | 1.5525 | 35.84 |
| 500 | 31.94 | 1.597 | 34.00 |
| 600 | 22.97 | 1.1485 | 52.53 |
| 700 | 21.82 | 1.091 | 54.91 |
| 800 | 22.42 | 1.121 | 53.66 |
| 900 | 20.56 | 1.028 | 57.52 |

### Examples 13 to 17— Geopolymer Composition with Carbon Nanotubes

A range of geopolymer compositions was prepared from fly ash (FA), ground granulated blast furnace slag (GGBS), high-magnesium nickel slag (HMNS) and carbon nanotubes, together with an alkaline activator, as follows:

Class F FA was obtained from Manjung power plant at Perak in Malaysia. The average particle size of the FA was about 18 μm. The specific surface area of the FA was around 1.29 m²/g.

GGBS was obtained from the steel plant at Penang in Malaysia. The average particle size of the GGBS was about 138 μm. The specific surface area of the GGBS was around 0.106 m²/g.

HMNS was obtained from the steel plant in Shaanxi Province, China. The average particle size of the HMNS was about 280 μm. The specific surface area of the HMNS was around 0.0536 m²/g.

The chemical compositions of the FA, GGBS and HMNS are summarised in Table 1 above, which were determined using x-ray fluorescence analysis.

Multi-walled carbon nanotubes were obtained from US Research Nanomaterials Inc., Houston, Tex. The carbon nanotubes were synthesized using chemical vapour deposition and had a purity of greater than 97%.

The carbon nanotubes had an outside diameter of from 5 to 15 nm, an inside diameter of from 3 to 5 nm and a length of from 40 to 50 μm.

The carbon nanotubes were added to acetone (50 mL) and dispersed using a high frequency sonicator (1000 W, BR-20MT-10 L) operated in a pulsed mode (50 seconds on, 10 seconds off) for 5 minutes. Thereafter, the FA, GGBS and HMNS were added and the resulting mixture stirred until uniform. The resulting mixture was placed in an oven at 60° C. for 1 hour to remove the acetone by evaporation.

An alkaline activator was prepared as follows:

A sodium silicate solution was obtained from South Pacific Chemicals Industries (SPCI) Ltd in Malaysia, with the chemical composition of 14.7 wt % Na₂O, 29.8 wt % SiO₂, and 55.5 wt % water.

A sodium hydroxide solution was prepared in the laboratory by dissolving sodium hydroxide pellets in water. To prepare the sodium hydroxide solution with a concentration of 12M, 480 grams of sodium hydroxide pellets supplied by Formosa Plastic Corporation, Taiwan were dissolved in 1 litre of distilled water. After cooling for 24 hours at room temperature, the sodium hydroxide solution was then mixed with the sodium silicate solution.

The mass ratio of sodium silicate to sodium hydroxide solution was 2.5. This provides a weight ratio of silicate ions and hydroxide ions of about 4:1.

The mixture of FA, GGBS, HMNS and carbon nanotubes was combined with the activator solution to form a paste in the amounts indicated in Table 13 below.

TABLE 13

| | Example | Example | Example | Example | Example |
|---|---|---|---|---|---|
| Component | 13 | 14 | 15 | 16 | 17 |
| Class F FA (kg/m³) | 1120 | 1117.76 | 1111.04 | 1104.32 | 1097.6 |
| GGBS (kg/m³) | 320 | 320 | 320 | 320 | 320 |
| HMNS (kg/m³) | 160 | 160 | 160 | 160 | 160 |
| Carbon Nanotubes | 0 | 2.24 | 8.96 | 15.68 | 22.4 |
| (kg/m³) | | | | | |
| Carbon Nanotubes | 0 | 0.2 | 0.8 | 1.4 | 2.0 |
| (wt %) | | | | | |
| Na₂SiO₃ solution | 71.42 | 71.42 | 71.42 | 71.42 | 71.42 |
| (kg/m³) | | | | | |
| NaOH solution (12M) | 28.57 | 28.57 | 28.57 | 28.57 | 28.57 |
| (kg/m³) | | | | | |
| Na₂SiO₃/NaOH weight | 2.5 | 2.5 | 2.5 | 2.5 | 2.5 |
| ratio | | | | | |
| Solid/alkaline activator | 2.0 | 2.0 | 2.0 | 2.0 | 2.0 |
| weight ratio | | | | | |

To prepare the geopolymer composition, the mixture of FA, GGBS, HMNS and carbon nanotubes was placed in a mixing vessel. The activator solution was added to the dry mixture and the mixture stirred mechanically to form a uniform paste.

The geopolymer paste was placed in flat and cubic moulds and cured at room temperature (20+/−2° C.) at a relative humidity of 85 to 90%.

### Example 18— Strength Tests of Geopolymer Composition with Carbon Nanotubes

The cured samples of Examples 13 to 17 were subjected to a quasi-static compression test to determine their compressive strength.

The compressive strength tests were performed after curing for 7 days using a universal testing machine (INSTRON 5582), under a load control regime with a loading rate of 0.3 kN/s in accordance with the ASTM C496 standard.

All tests were carried out in triplicate and average values were obtained and used as the results.

The compressive strength tests were conducted after heat treatment of the cured samples at different temperatures.

For the samples heated to 300° C., each sample was heated in an oven with the temperature increased at a rate of 6° C./min until the test temperature was reached. The sample was held at the test temperature for 2 hours. The sample was then allowed to cool to room temperature.

For the samples cooled to −36° C., each sample was immersed in liquid nitrogen at −96° C. until reaching the test temperature. The sample was then allowed to warm to room temperature.

The results of the compressive strength tests are summarised in Table 14 below.

TABLE 14

| | | Carbon Nanotube | Compressive |
|---|---|---|---|
| | Temperature | Content | Strength |
| | (° C.) | (% wt) | (MPa) |
| Example 13 | Room Temp. | 0 | 18.0 |
| | −36 | 0 | 17.7 |
| | 300 | 0 | 16.6 |
| Example 14 | Room Temp. | 0.2 | 18.2 |
| | −36 | 0.2 | 17.8 |
| | 300 | 0.2 | 15.7 |
| Example 15 | Room Temp. | 0.8 | 22.0 |
| | −36 | 0.8 | 20.3 |
| | 300 | 0.8 | 20.0 |
| Example 16 | Room Temp. | 1.4 | 21.5 |
| | −36 | 1.4 | 20.7 |
| | 300 | 1.4 | 20.1 |
| Example 17 | Room Temp. | 2.0 | 21.2 |
| | −36 | 2.0 | 20.6 |
| | 300 | 2.0 | 19.5 |

### Example 19— Electrical Conductivity Tests of Geopolymer Composition with Carbon Nanotubes

The cured samples of Examples 13 to 17 were subjected to a test to determine their electrical conductivity.

Each sample was held between two opposing copper sheets. To improve the electrical contact between the copper sheets and the sample, the faces of the sample in contact with the sheets were painted with a high purity silver coating. The electrical conductivity between the cooper sheets was measured using a digital multi-meter (Keithly 6517B) at room temperature (20° C.+/−2° C.).

The in-plane electrical conductivity a of the samples was estimated using the following equation:

σ=L/RA

where:

L is the sample length (m);

R is the electrical resistance (Ω); and

A is the cross-sectional area of the sample (m²).

The results are summarised in Table 15 below.

TABLE 15

| | Carbon Nanotube | Electrical |
|---|---|---|
| | Content | Conductivity |
| | (% wt) | (S/m*10⁻⁷) |
| Example 13 | 0 | 1.1454 |
| Example 14 | 0.2 | 2.3880 |
| Example 15 | 0.8 | 8.0812 |
| Example 16 | 1.4 | 11.11 |
| Example 17 | 2.0 | 13.0655 |

### Example 20— Electrical Heating Tests of Geopolymer Composition with Carbon Nanotubes

A cured sample of Example 17 was subjected to a test to determine their electrical heating properties.

The sample was held between two opposing copper sheets. To improve the electrical contact between the copper sheets and the sample, the faces of the sample in contact with the sheets were painted with a high purity silver coating. A current of 0.13 A was applied to the copper sheets. The temperature of the sample was measured over time.

The results are summarised in Table 16 below.

TABLE 16

| Time (s) | Temperature (° C.) |
|---|---|
| 0 | 25 |
| 200 | 39 |
| 400 | 47 |
| 600 | 52 |
| 800 | 57 |
| 1000 | 59 |
| 1100 | 66 |

### Example 21— Geopolymer Composition with Rubber Powder

A geopolymer paste composition was prepared from fly ash (FA), ground granulated blast furnace slag (GGBS), high-magnesium nickel slag (HMNS) and rubber powder, together with an alkaline activator, as follows:

Class F FA was obtained from Manjung power plant at Perak in Malaysia. The average particle size of the FA was about 18 μm. The specific surface area of the FA was around 1.29 m²/g.

GGBS was obtained from the steel plant at Penang in Malaysia. The average particle size of the GGBS was about 138 μm. The specific surface area of the GGBS was around 0.106 m²/g.

HMNS was obtained from the steel plant in Shaanxi Province, China. The average particle size of the HMNS was about 280 μm. The specific surface area of the HMNS was around 0.0536 m²/g.

The chemical compositions of the FA, GGBS and HMNS are summarised in Table 1 above, which were determined using X-ray fluorescence analysis.

Rubber powder was obtained from Crumb Rubber Ltd, Plymouth, UK. The rubber powder was manufactured from waste vehicle tyres and had an average particle size of less than 8 μm (ultra-fine rubber powder).

The FA, GGBS, HMNS and rubber powder was combined and mixed to form a homogeneous dry mixture.

An alkaline activator was prepared as follows:

A sodium silicate solution was obtained from South Pacific Chemicals Industries (SPCI) Ltd in Malaysia, with the chemical composition of 14.7 wt % Na₂O, 29.8 wt % SiO₂, and 55.5 wt % water.

A sodium hydroxide solution was prepared in the laboratory by dissolving sodium hydroxide pellets in water. To prepare the sodium hydroxide solution with a concentration of 12M, 480 grams of sodium hydroxide pellets supplied by Formosa Plastic Corporation, Taiwan were dissolved in 1 litre of distilled water. After cooling for 24 hours at room temperature, the sodium hydroxide solution was then mixed with the sodium silicate solution.

The mass ratio of sodium silicate to sodium hydroxide solution was 2.5. This provides a weight ratio of silicate ions and hydroxide ions of about 4:1.

The mixture of FA, GGBS, HMNS and rubber powder was combined with the activator solution in the amounts indicated in Table 17 below.

TABLE 17

| Component | Example 21 |
|---|---|
| Class F FA (kg/m³) | 864 |
| GGBS (kg/m³) | 320 |
| HMNS (kg/m³) | 160 |
| Rubber Powder (kg/m³) | 96 |
| Rubber Powder (wt %) | 10 |
| Na₂SiO₃ solution (kg/m³) | 71.42 |
| NaOH solution (12M) (kg/m³) | 28.57 |
| Na₂SiO₃/NaOH weight ratio | 2.5 |
| Solid/alkaline activator weight ratio | 2.0 |

To prepare the geopolymer composition, the mixture of FA, GGBS, HMNS and rubber powder was placed in a mixing vessel. The activator solution was added to the dry mixture and the mixture stirred mechanically to form a uniform paste.

The geopolymer paste was placed in cubic moulds and cured at room temperature (20+/−2° C.) at a relative humidity of 85 to 90%.

### Example 22— Strength Tests of Geopolymer Composition with Rubber Powder

The cured sample of Example 21 was subjected to a test to determine its compressive strength.

The compressive strength tests were performed after curing for 28 days using a universal testing machine, under a load control regime with a loading rate of 0.3 kN/s in accordance with the ASTM C496 standard.

All tests were carried out in triplicate and average values were obtained and used as the results.

The cured geopolymer composition comprising rubber powder as a filler exhibited a compressive strength at room temperature of 44.25 MPa.

### Example 23— Geopolymer Composition with Sugar Powder Waste

A geopolymer composition was prepared from fly ash (FA), ground granulated blast furnace slag (GGBS), high-magnesium nickel slag (HMNS) and sugar powder waste, together with an alkaline activator, as follows:

Class F FA was obtained from Manjung power plant at Perak in Malaysia. The average particle size of the FA was about 18 μm. The specific surface area of the FA was around 1.29 m²/g.

GGBS was obtained from the steel plant at Penang in Malaysia. The average particle size of the GGBS was about 138 μm. The specific surface area of the GGBS was around 0.106 m²/g.

HMNS was obtained from the steel plant in Shaanxi Province, China. The average particle size of the HMNS was about 280 μm. The specific surface area of the HMNS was around 0.0536 m²/g.

The chemical compositions of the FA, GGBS and HMNS are summarised in Table 1 above, which were determined using X-ray fluorescence analysis.

Sugar powder waste was obtained from Group Cevital Agro-Industrie Spa, Algeria. The sugar powder had an average particle size of less than 30 μm.

The FA, GGBS, HMNS and sugar powder waste was combined and mixed to form a homogeneous dry mixture.

An alkaline activator was prepared as follows:

A sodium silicate solution was obtained from South Pacific Chemicals Industries (SPCI) Ltd in Malaysia, with the chemical composition of 14.7 wt % Na₂O, 29.8 wt % SiO₂, and 55.5 wt % water.

A sodium hydroxide solution was prepared in the laboratory by dissolving sodium hydroxide pellets in water. To prepare the sodium hydroxide solution with a concentration of 12M, 480 grams of sodium hydroxide pellets supplied by Formosa Plastic Corporation, Taiwan were dissolved in 1 litre of distilled water. After cooling for 24 hours at room temperature, the sodium hydroxide solution was then mixed with the sodium silicate solution.

The mass ratio of sodium silicate to sodium hydroxide solution was 2.5. This provides a weight ratio of silicate ions and hydroxide ions of about 4:1.

The mixture of FA, GGBS, HMNS and sugar powder waste was combined with the activator solution in the amounts indicated in Table 18 below.

TABLE 18

| Component | Example 23 |
|---|---|
| Class F FA (kg/m³) | 864 |
| GGBS (kg/m³) | 320 |
| HMNS (kg/m³) | 160 |
| Sugar Powder Waste (kg/m³) | 96 |
| Sugar Powder Waste (wt %) | 10 |
| Na₂SiO₃ solution (kg/m³) | 71.42 |
| NaOH solution (12M) (kg/m³) | 28.57 |
| Na₂SiO₃/NaOH weight ratio | 2.5 |
| Solid/alkaline activator weight ratio | 2.0 |

To prepare the geopolymer composition, the mixture of FA, GGBS, HMNS and sugar powder waste was placed in a mixing vessel. The activator solution was added to the dry mixture and the mixture stirred to form a uniform paste.

The geopolymer paste was placed in cubic moulds and cured at room temperature (20+/−2° C.) at a relative humidity of 85 to 90%.

### Example 24— Strength Tests of Geopolymer Composition with Sugar Powder Waste

The cured sample of Example 23 was subjected to a test to determine its compressive strength.

The compressive strength tests were performed after curing for 7 days using a universal testing machine, under a load control regime with a loading rate of 0.3 kN/s in accordance with the ASTM C496 standard.

All tests were carried out in triplicate and average values were obtained and used as the results.

The cured geopolymer composition comprising sugar powder waste as a filler exhibited a compressive strength at room temperature of 18 MPa.

1. A geopolymer composition comprising:
(a) fly ash (FA);
(b) ground granulated blast-furnace slag (GGBS); and
(c) high-magnesium nickel slag (HMNS).

2. The geopolymer composition according to claim 1, wherein the weight ratio of fly ash and ground granulated blast-furnace slag is greater than 1:1.

3. The geopolymer composition according to claim 1, wherein the weight ratio of fly ash and high-magnesium nickel slag is greater than 1.1.

4. The geopolymer composition according to claim 1, wherein the weight ratio of ground granulated blast-furnace slag and the high-magnesium nickel slag is from 10:1 to 1:2.

5. The geopolymer composition according to claim 1, further comprising a filler, wherein the filler is one or more of an aggregate, an allotrope of carbon, a rubber, an elastomer and a plant material.

6. (canceled)

7. The geopolymer composition according to claim 5, wherein the allotrope of carbon is a carbon nano-structure material.

8. The geopolymer composition according to claim 5, wherein the filler is an allotrope of carbon and is present in an amount of from 0.2% by weight.

9. A method for forming a geopolymer composition, the method comprising: providing a geopolymer precursor comprising:
(a) fly ash (FA);
(b) ground granulated blast-furnace slag (GGBS); and
(c) high-magnesium nickel slag (HMNS);
combining components (a) to (c) with an activator, the activator comprising a silicate and a base in solution in a solvent; and
allowing the resulting mixture to cure.

10. The method according to claim 9, wherein the silicate comprises an alkali metal silicate.

11. The method according to claim 9, wherein the base comprises a basic salt of an alkali metal, an alkaline earth metal or ammonia.

12. (canceled)

13. The method according to claim 9, wherein the concentration of basic anions in the solvent is from 5M.

14. The method according to claim 9, wherein the weight ratio of the geopolymer precursor and the activator is greater than 1:1.

15. A method for forming a geopolymer composition comprising one or more of fly ash, granulated blast furnace slag and high-magnesium nickel slag and one or more allotropes of carbon, the method comprising:
i) providing a suspension of the carbon allotrope in a solvent;
ii) combining the suspension provided in step i) with one or more of fly ash, granulated blast furnace slag and high-magnesium nickel slag; and
iii) combining the resulting mixture with an activator.

16. The method according to claim 15, wherein the solvent is an organic solvent, selected from one or more of alcohols, aldehydes and ketones.

17. The method according to claim 16, wherein the solvent comprises acetone.

18. The method according to claim 15, wherein the allotrope of carbon is a carbon nano-structure material.

19-25. (canceled)
